(19) United States
(12) Patent Application Publication
(10) Pub. No.: US 2002/0157342 A1
(43) Pub. Date: Oct. 31, 2002

(54) Profile for shop window construction

(76) Inventor: Jean Bourly, Reims (FR)

Correspondence Address: John S. Egbert, Harrison & Egbert, 7th Floor, 412 Main Street, Houston, TX, 77002, US

(21) Appl. No.: 10/121,450

(22) Filed: Apr. 12, 2002

(30) Foreign Application Priority Data
Apr. 19, 2001 (FR) 01 05306

(51) Int. Cl. E06B 1/04; E04C 2/38

(52) U.S. Cl. 52/656.5; 52/204.1; 52/204.5

(57) ABSTRACT

The invention concerns a layout of shop window profiles (1, 2), assembled edge to edge, by their ends, (e₁, e₂), whereas said layout comprises means for fastening said profiles together.

According to the invention,

each profile (1, 2) comprises at least a web (3) and a wing (4, 5) and shows at least two so-called longitudinal edges (6), extending from one end to the other of the profile and linked in all or in part of said web(s) (3) and said wing(s) (4), each said profile defining a so-called internal volume (8), circumscribed by said web(s) (3) and said wing(s) (4) linking said longitudinal edges (6) and by a virtual plane going through said edges,

said fastening means are composed of a weld seam (9) linking said profiles at their junction, the weld seam (9) being situated in said internal volume (8) of the profiles.

The invention also concerns a chassis and a frame for window, glazed door and/or analogous formed of such a layout.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention concerns a layout for shop window construction, as well as a frame and a chassis for a window, glazed door and/or similar, composed of such a layout.

### BACKGROUND OF THE INVENTION

Currently, in the field of shop window construction, it is known to use frames or chassis formed of profiles, of closed cross-section steel, each delineating one of the sides of said frame or chassis and assembled together, edge to edge, by their ends. To do so, a weld seam is provided at their junction zone, on the visible surfaces.

Although it is quite widespread, such a solution exhibits numerous shortcomings. The weld seam is not aesthetic and must be partially eliminated so that the manufactured frame or chassis preserves a satisfying aspect. Such a partial elimination of the weld seam is also necessary to allow correct operation of the fitted window, glazed door or similar. It is thus necessary to perform finish-machining operations, tricky to be performed.

Besides, these operations weaken the resistance of the weld seam up to 50 or 60% of its initial resistance. The frame or chassis loses some of its strength. Its water and air tightness properties also decrease, which limits its insulation power.

Besides, the presence of an external weld seam makes finishing operations more difficult such as, for example, polishing, application of patina or others.

The purpose of the invention is to suggest a layout of shop window profiles, assembled edge to edge, by their ends which remedies the shortcomings mentioned above and wherein the profiles are fixes to one another without detriment to the aesthetic aspect of said layout while increasing its strength and/or its tightness.

Another purpose of the invention is to suggest a layout of assembled shop window profiles, edge to edge, by their ends whereof the finishing operations are facilitated.

Another purpose of the invention is to suggest a layout of shop window profiles, assembled edge to edge, by their ends wherein the fastening means of the profiles together can be masked.

Other purposes and advantages of the invention will appear during the following description which is only given for exemplification purposes and which does not purport to limit said invention.

### BRIEF SUMMARY OF THE INVENTION

The invention concerns a layout of shop window profiles, assembled edge to edge, by their ends, whereas said layout comprises means for fastening said profiles together, characterised in that:

each profile comprises at least a web and a wing and shows at least two so-called longitudinal edges, extending from one end to the other of the profile and linked in all or in part of said web(s) and said wing(s), each said profile defining a so-called internal volume, circumscribed by said web(s) and said wing(s) linking said longitudinal edges and by a virtual plane going through said edges,

said fastening means are composed of a weld seam linking said profiles at their junction, the weld seam being situated in said internal volume of the profiles.

According an advantageous embodiment, the metal profiles of the layout according to the invention are composed of bronze. They exhibit therefore a top range effect.

Besides, it should be noted that with such a material, the realization of an internal weld seam is particularly necessary for the layout to keep its aesthetic aspect. Indeed, the bronze being an alloy, the material used for welding exhibits compulsorily a tone different of the tone of the profiles. It is therefore necessary to be able to mask said weld seam to preserve the effect desired.

The invention also concerns a frame and a chassis for a window, glazed door and/or similar, composed of a layout such as described above.

### BRIEF DESCRIPTION OF THE SEVERAL VIEWS OF THE DRAWINGS

The invention will be understood better when reading the following description together with the appended drawings wherein:

FIG. 1 is a partial illustration, as a front view, of an embodiment of the layout according to the invention.

FIG. 2 is a cross-sectional view along the line II-II represented on previous FIG. 1.

FIG. 3 is a cross-sectional view along the line III-III represented on previous FIG. 1.

FIG. 4 is a cross-sectional view along the line IV-IV represented on previous FIG. 2.

FIG. 5 is a partial illustration according to a transversal cross-sectional plane of a window, glazed door and/or similar comprising other embodiments of the layout according to the invention, forming a frame and a chassis also complying with the invention.

FIGS. 6a to 6g illustrate different examples of profile sections of the layout according to the invention.

### DETAILED DESCRIPTION OF THE INVENTION

The invention concerns first of all a profile for shop window construction.

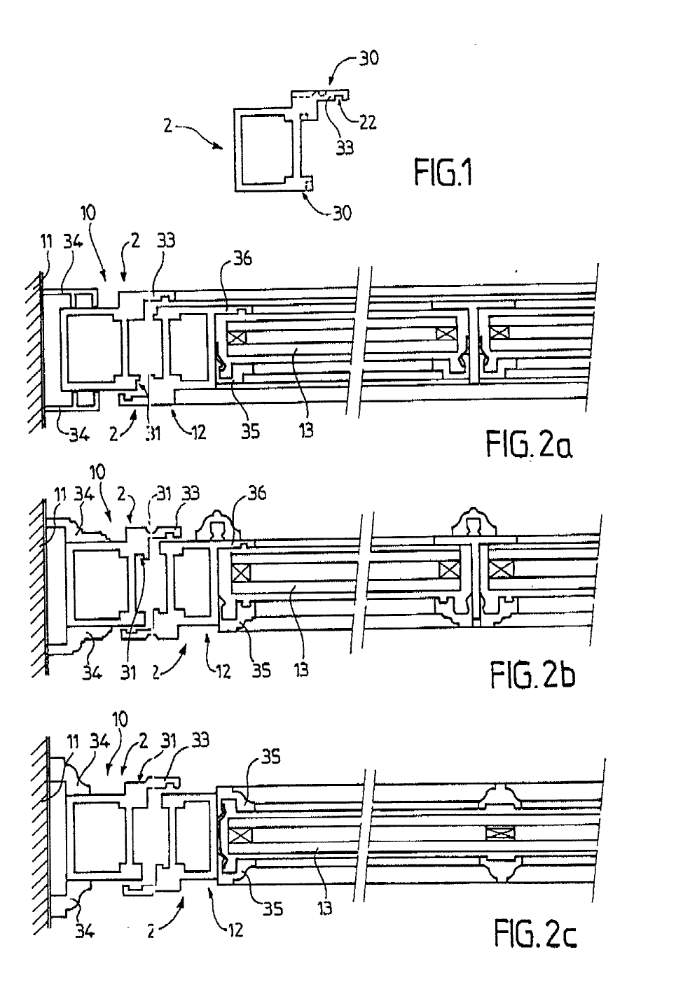

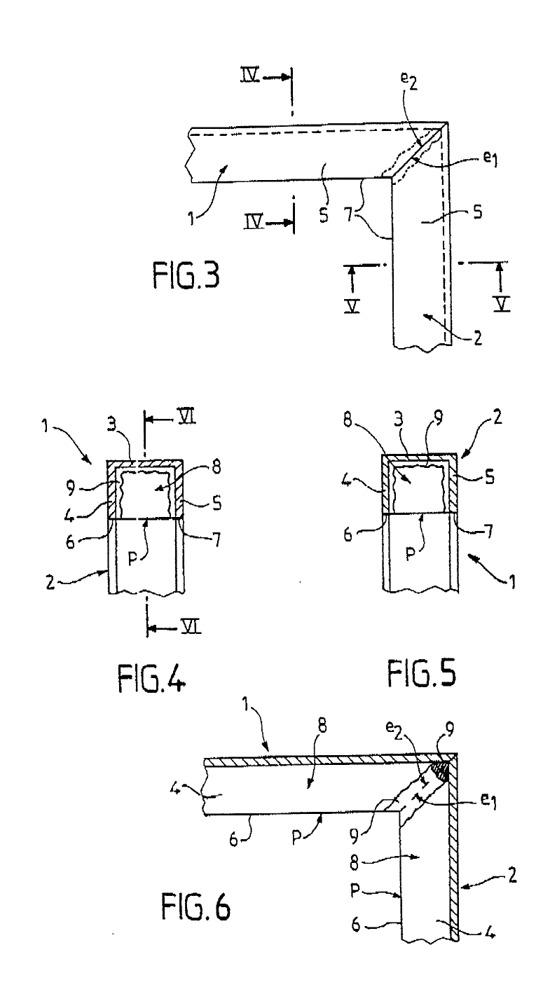

As illustrated on FIGS. 1 to 4, in the layout according to the invention, the profiles 1, 2 are assembled edge to edge, by their ends e₁, e₂.

Said profiles 1, 2, are for example, perpendicular two by two. Their ends can be chamfered. The edges of the ends of said profiles will therefore be tilted, notably, of approx. 45° with respect to their longitudinal edges.

According to the invention, each profile comprises at least a web 3 and a wing 4, 5 and exhibits at least two so-called longitudinal edges 6, 7, extending from one end to the other of the profile and linked, in all or in part of said web(s) 3 and of said wing(s) 4, 5, each said profile delineating a so-called volume 8, circumscribed by said web(s) 3 and said wing(s) 4 linking said longitudinal edges 6, 7 and by a virtual plane P going through said edges.

Said profiles thus exhibit a “semi-open” right section, i.e. extending according to at least two different directions and said profiles are in themselves neither tubular nor composed of a simple plan metal bond. As developed further, said profiles can exhibit a U-shaped section or others.

According to the invention, to enable to link said profiles, said layout comprises fastening means composed of a weld seam 9 linking said profiles at their junction e₁, e₂, said weld seam 9 being situated in said internal volume 8 of the profiles 1, 2.

By providing “semi-open” profiles and by placing the weld seam 9 in the internal volume that they delineate, said weld seam 9 is thus masked and need not be eliminated partially, as previously. The link between the profiles is thus made stronger and tighter. Similarly, no excessive thickness of material cue to the weld seem being available at the external faces of the profiles, the finishing works of said excessive thickness are facilitated.

FIG. 5 illustrates a vertical stanchion 10 of a first layout, notably a frame, slaved to a wall 11, and a vertical stanchion 12 of a second layout, notably a chassis, to which panes are slaved, notably double glazing.

As illustrated by this particular example, all or part of the profiles 1, 2 layouts according to the invention can be fitted with closing means 14 of a portion at least of their internal volume 8. It will be thus possible to mask said wold seam 9 entirely.

The latter is more particularly intended, for example, along the portion of said web(s) 3 and of said wing(s) 4, 5 being in the portion of said internal volume 8 sealed said closing means 14. Said closing means 14 can besides extend from one end to the other of said profiles.

Said profiles exhibit, for example, at least two parallel branches, notably composed of said wings 4, 5 each fitted, opposite one another, with a stop 15, 16. Said closing means 14 can then be composed, notably, of rabbets 17 and/or leaves resting on said stops 15, 16. Said closing means can also be composed of another profile.

Said rabbets 17 may accommodate a gasket 18.

As illustrated on FIG. 5, the rabbets 17 closing each of the profiles 2 represented rest against one another by their gasket 18 when the window 13 is in closed position.

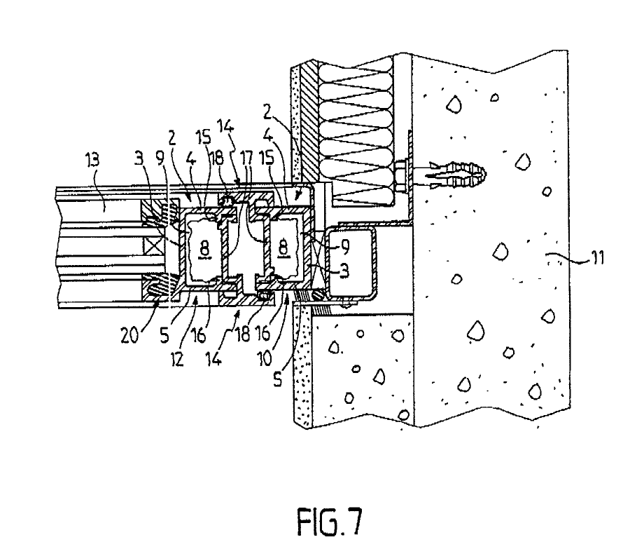

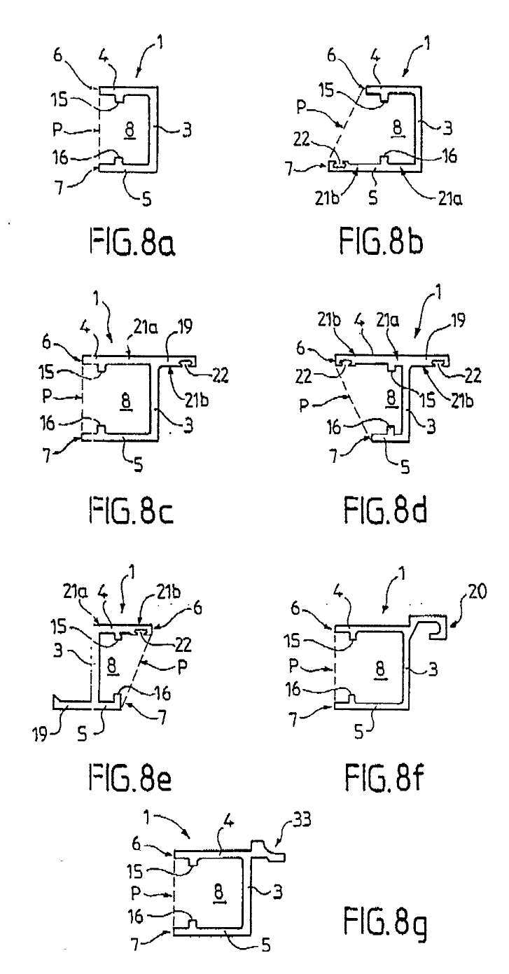

As regards the form of the profiles, as already mentioned, said form can be quite varied. For exemplification purposes, as illustrated on FIGS. 6a to 6g, said profiles comprise one said web 3 and at least two said wings 4, 5 extending opposite one another from ends of said web 3, perpendicularly to said ends.

It can thus be defined a “basic” section, such as illustrated on FIG. 6a, wherein both wings 4, 5 exhibit the same length. With reference again to FIG. 5, it can be noted that the stanchion 10 of the frame exhibits such a section.

One of the des wings 14 can also be extended beyond the other 15, as illustrated on FIG. 6b. It can also be extended by a third wing 19 situated on the other side of the web 3, as illustrated on FIG. 6c. Both previous characteristics can still be combined, either at the same wing, as illustrated on FIG. 6d or at the other wing, as illustrated on FIG. 6e.

With reference again to FIGS. 6f and 6g, it can be noted that the profiles according to the invention can also comprise a protuberance 20, notably intended to allow as well hooking a gasket as illustrated an FIG. 5 with the stanchion 12 of the chassis or an excessive thickness 30, notably intended for the realization of patterns by machining.

With reference again to FIGS. 6b, 6c, 6d or 6e, it can be noted that one 4 at least of said branches fitted with one of said stops 15, 16 exhibits, on the one hand, a first portion 21a delineating a portion of the contour of the internal volume 8 sealed by said closing means 14, and, on the other hand, a second so-called free portion 21b, exhibiting one said longitudinal specific groove 22, capable of accommodating a gasket. Said first and second portions 21a, 21b can be situated on either side of the stop 11 in question or on the same side, according to the profile used.

The profiles of a same layout according to the invention may exhibit the some section.

Consequently, as already mentioned, according to an advantageous embodiment, said profiles will be formed of bronze.

Said weld seam 9 is, for example, primarily based on copper. It may be, notably, a weld seam made of copper-aluminum.

Welding can be performed with an MIG-type device under argon-type neutral gas.

To assemble a layout according to the invention, one can proceed as follows. One positions against one another the ends of the profiles forming the layout. The junction can be welded at their internal volume which can be sealed using rabbets.

One can also realize finishing operations such as polishing or applying a patina on the external surfaces of said profiles.

Naturally, other embodiments, available to the man of the art, could have been contemplated without departing from the framework of the invention.

I claim:

1. A layout of assembled shop window profiles (1, 2), edge to edge, by their ends, e₁, e₂, whereas said layout comprises means for fastening said profiles together, characterized in that.
each profile (1, 2) comprises at least a web (3) and a wing (4, 5) and shows at least two so-called longitudinal edges (6, 7), extending from one end to the other of the profile and linked in all or in part of said web(s) (3) and said wing(s) (4, 5), each said profile defining a so-called internal volume (8), circumscribed by said web(s) (3) and said wing(s) (4, 5) linking said longitudinal edges (6, 7) and by a virtual plane going through said edges,
said fastening means are composed of a weld seem (9) linking said profiles at their junction, the weld seam (9) being situated in said internal volume (8) of the profiles.

2. A layout according to claim 1, wherein all or part of said profiles are fitted with closing means (14) or a portion at least of their internal volume (8).

3. A layout according to claim 2, wherein:
said profiles exhibit at least two parallel branches (4, 5) each fitted, opposite one another, with a stop (15, 16),
said closing means (14) can be composed of rabbets (17) and/or leaves resting on said stops (15, 16).

4. A layout according to claim 3, wherein one at least of said branches each fitted with one of said stops exhibits a first portion (21a) delineating a portion of the contour of the internal volume (8) sealed by said closing means (14), and a second so-called free portion (21b), exhibiting a longitudinal groove (22), capable of accommodating a gasket.

5. A layout according to claim 1, wherein said profiles comprise one said web (3) and at least two said wings (4, 5) extending opposite one another from ends of said web (3), perpendicularly to said web.

6. A layout according to any of the claims 1 to 5, wherein said profiles are made of bronze.

7. A layout according to claim 6, wherein said weld seam is primarily based on copper.

8. A layout according to claim 6, wherein said weld seam is made of copper-aluminum,

9. A chassis for window, glazed door and/or analogous formed of a layout according any of the claims 1 to 8.

10 . A frame for window, glazed door and/or analogous formed of a layout according any of the claims 1 to 8.
